(19) United States
(12) Patent Application Publication
(10) Pub. No.: US 2026/0192212 A1
(43) Pub. Date: Jul. 9, 2026

(54) DISTILLATION SYSTEM THAT USES GAS TURBINE ENGINE EXHAUST

(71) Applicant: HONEYWELL INTERNATIONAL INC., Charlotte, NC (US)

(72) Inventors: Matthew Dunn, Phoenix, AZ (US); Kevin Dittmar, Phoenix, AZ (US); Bruce Bouldin, Phoenix, AZ (US)

(73) Assignee: HONEYWELL INTERNATIONAL INC., Charlotte, NC (US)

(21) Appl. No.: 19/013,173

(22) Filed: Jan. 8, 2025

(51) Int. Cl. B01D 1/00; B01D 1/14; C02F 1/04; C02F 1/10; F02C 6/18

(52) U.S. Cl. CPC B01D 1/0058; B01D 1/0082; B01D 1/14; C02F 1/048; C02F 1/10; F02C 6/18; C02F 2209/42; F05D 2220/70

(57) ABSTRACT

A distillation system includes a tank, a diffuser, and a gas turbine engine. The tank has a plurality of walls that together define an inner volume. A divider wall is disposed within the tank and divides the inner volume into a main chamber and a settling chamber. The main chamber has at least a fluid inlet port and an exhaust gas inlet port, the settling chamber has at least an exhaust gas outlet port, and the divider wall has a divider wall opening formed therein that provides fluid communication between the main chamber and the settling chamber. The diffuser is disposed within the main chamber and is coupled to the exhaust gas inlet port. The gas turbine engine is in fluid communication with the exhaust gas inlet port and is configured, during operation thereof, to discharge exhaust gas into the main chamber via the diffuser.

### TECHNICAL FIELD

The present disclosure generally relates to distillation systems, and more particularly to a distillation system that uses exhaust from a gas turbine engine.

### BACKGROUND

Various industrial processes, including hydraulic fracturing (i.e., fracking), produce wastewater. The wastewater that is produced may include dissolved salts, metals, and other contaminants. Preferably, this wastewater undergoes a treatment process to remove the dissolved salts, metals, and other contaminants so that the recovered, clean water can be reused in future fracking operations or various other purposes such as, for example, agricultural irrigation. Various treatment processes are used to treat such wastewater. These include membrane filtration (like reverse osmosis), chemical precipitation, advanced oxidation processes, and distillation.

A typical distillation process involves heating the wastewater, which separates the water from the dissolved salts, metals, and other contaminants. The water vapor is then condensed to produce clean water for reuse. Although many advantages are associated with distillation, many systems proposed and/or built to-date are relatively expensive and/or complex.

Hence, there is a need for a distillation system that can be used to treat wastewater from various industrial processes, such as fracking, and that is relatively less costly and/or relatively less complex as compared to known systems. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a distillation system includes a tank, a diffuser, and a gas turbine engine. The tank has a first end wall, a second end wall, a front wall, a back wall, a top wall, and a bottom wall that together define an inner volume. A divider wall is disposed within the tank and divides the inner volume into a main chamber and a settling chamber. The main chamber has at least a fluid inlet port and an exhaust gas inlet port, the settling chamber has at least an exhaust gas outlet port, and the divider wall has a divider wall opening formed therein that provides fluid communication between the main chamber and the settling chamber. The diffuser is disposed within the main chamber and is coupled to the exhaust gas inlet port. The gas turbine engine is in fluid communication with the exhaust gas inlet port and is configured, during operation thereof, to discharge exhaust gas into the main chamber via the diffuser.

In another embodiment, a distillation system includes a tank, a diffuser, a first nozzle wall, a first baffle wall, a second nozzle wall, a second baffle wall, a gas turbine engine, and an engine control. The tank has a first end wall, a second end wall, a front wall, a back wall, a top wall, and a bottom wall that together define an inner volume. The divider wall is disposed within the tank and divides the inner volume into a main chamber and a settling chamber. The main chamber has at least a fluid inlet port and an exhaust gas inlet port, the settling chamber has at least an exhaust gas outlet port, and the divider wall has a divider wall opening formed therein that provides fluid communication between the main chamber and the settling chamber. The diffuser is disposed within the main chamber and is coupled to the exhaust gas inlet port. The first nozzle wall is disposed within the main chamber and is coupled to the diffuser. The first nozzle wall is spaced apart from the front wall of the tank to define, within the main chamber, an inlet volume between the first nozzle wall and the front wall. The first nozzle wall has at least one first baffle nozzle formed therein. The first baffle wall has a plurality of first baffle openings extending therethrough. The first baffle wall is disposed within the main chamber and is spaced apart from the first nozzle wall to define, within the main chamber, a first mixing volume between the first nozzle wall and the first baffle wall. The second nozzle wall is disposed within the main chamber and is spaced apart from the first baffle wall to define, within the main chamber, an intermediate volume. The second nozzle wall has at least one second baffle nozzle formed therein. The second baffle wall has a plurality of second baffle openings extending therethrough. The second baffle wall is disposed within the main chamber and spaced apart from the second nozzle wall to define, the within the main chamber, a second mixing volume between the second nozzle wall and the second baffle wall. The second baffle wall is further spaced apart from the back wall of the tank to define, within the main chamber, an outlet volume. The gas turbine engine is in fluid communication with the exhaust gas inlet port and is configured, during operation thereof, to discharge exhaust gas into the inlet volume via the diffuser. The engine control is in operable communication with the gas turbine engine, and configured to control the operation of the gas turbine engine.

Furthermore, other desirable features and characteristics of the distillation system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 depicts a simplified functional schematic diagram of one embodiment of a distillation system;

FIG. 2 depicts a transparent plan view of one embodiment of a tank that may be used to implement the distillation system of FIG. 1;

FIG. 3 depicts a cross-sectional view of the tank depicted in FIG. 2; and

FIG. 4 depicts the cross-section view of FIG. 3, illustrating exhaust gas flow into and through the tank.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

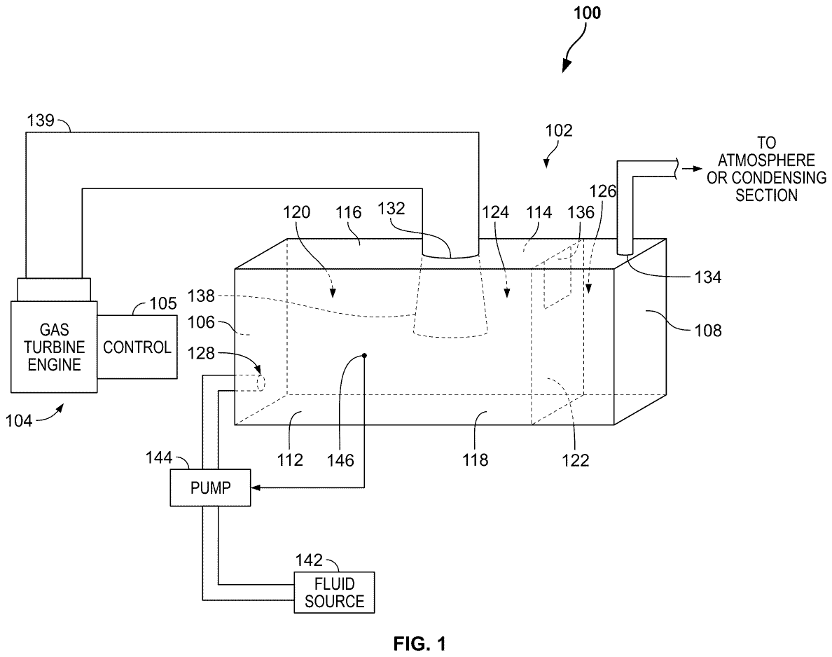

Referring now to FIG. 1, a simplified functional schematic diagram of one embodiment of a distillation system 100 is depicted and includes a tank 102 and a gas turbine engine 104. The tank 102 has a first end wall 106, a second end wall 108, a front wall 112, a back wall 114, a top wall 116, and a bottom wall 118. Together, the walls 106-116 define an inner volume 120.

As FIG. 1 also depicts, a divider wall 122 is disposed within the tank 102 and divides the inner volume 120 into a main chamber 124 and a settling chamber 126. The main chamber 124 has at least a fluid inlet port 128 and an exhaust gas inlet port 132, and the settling chamber 126 at least an exhaust gas outlet port 134. The divider wall 122 has a divider wall opening 136 formed therein that provides fluid communication between the main chamber 124 and the settling chamber 126. It should be noted that the exhaust gas outlet port 134 may be variously sized to meet desired performance characteristics. Preferably, however, it has a relatively large diameter to reduce the velocity of the gas being discharged and to reduce any entrained mist within the gas. In one embodiment, the exhaust gas outlet port 134 has a 36-inch diameter.

The gas turbine engine 104 is in fluid communication with the exhaust gas inlet port 132. During operation of the gas turbine engine 104, the gas turbine engine 104 discharges exhaust gas into the main chamber 124. And more specifically, the gas turbine engine 104 discharges exhaust gas into the main chamber 124 via a diffuser 138 that is disposed within the main chamber 124 and is coupled to the exhaust gas inlet port 132. In some embodiments, such as the one depicted in FIG. 1, an exhaust duct 139 is coupled between the gas turbine engine 104 and the exhaust gas inlet port 132. The exhaust duct 139, when included, is configured to direct the exhaust gas discharged from the gas turbine engine 104 into the exhaust gas inlet port 132.

Before proceeding further, it is noted that the distillation system 100, at least in the depicted embodiment, additionally includes an engine control 105 that is in operable communication with the gas turbine engine 104. The engine control 105 is configured to control the operation of the gas turbine engine 104. It will be appreciated that the gas turbine engine 104 may be implemented using any one of numerous types of gas turbine engines 104. In one particular embodiment, however, the gas turbine engine 104 is implemented using an auxiliary power unit (APU), such as an APU that is typically configured for use in commercial aircraft. It will additionally be appreciated that the engine control 105 may be implemented using any one of numerous known engine controls.

No matter how the gas turbine engine 104 and engine control 105 are specifically implemented, it will be appreciated that the diffuser 138 functions to slow the flow of the exhaust gas discharged by the gas turbine engine 104. The diffuser 138 additionally functions to promote exhaust flow distribution along the length of the main chamber 124 to better interact with the fluid (not shown in FIG. 1), such as wastewater, that is supplied to the inner volume 120 of the tank 102. It will be appreciated that the sides of the diffuser 138 may be disposed at any one of numerous angles relative to exhaust gas inlet port 132. In one particular embodiment, the sides are angled at about 5-degrees. However, this angle may vary as needed to meet desired performance characteristics.

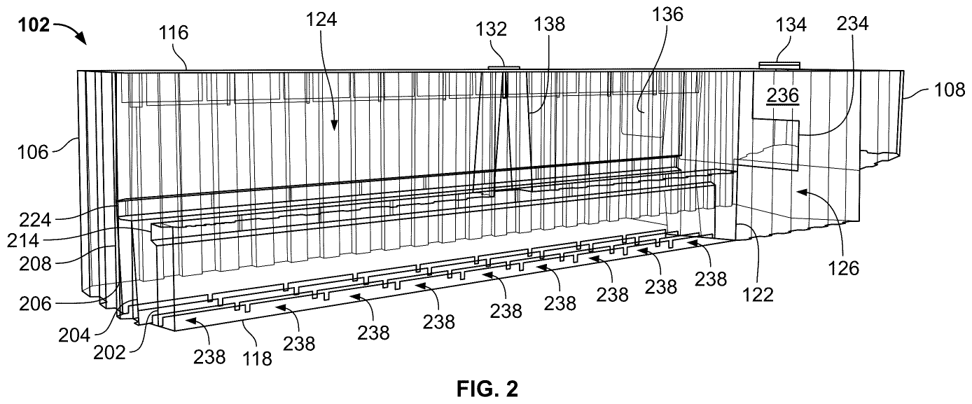

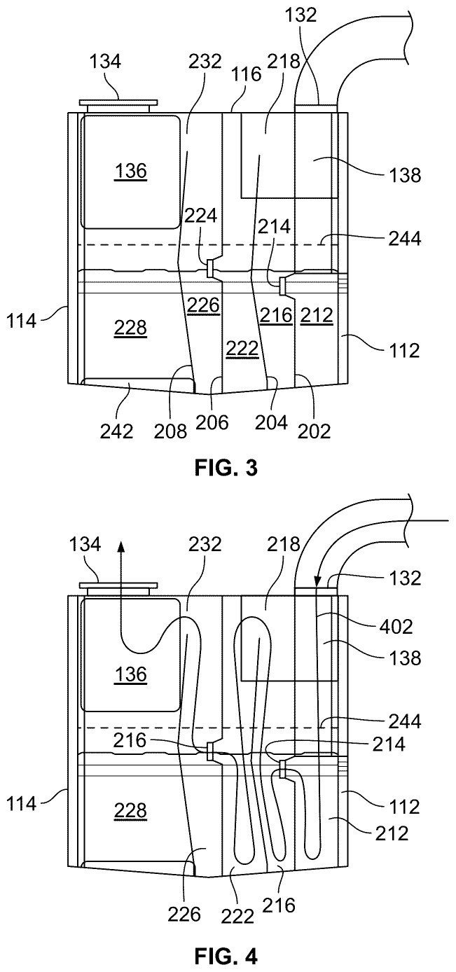

In addition to the diffuser 138, additional structural features are included within the inner volume 120 of the tank 102 to further improve the distillation process implemented by the distillation system 100. For clarity, these structural features are not depicted in FIG. 1. However, these structural features are depicted in FIGS. 2 and 3, and with reference thereto will now be described.

The additional structural features include a first nozzle wall 202, a first baffle wall 204, a second nozzle wall 206, and a second baffle wall 208. The first nozzle wall 202 is disposed within the main chamber 124 and is coupled to the diffuser 138. The first nozzle wall 202 is also spaced apart from the front wall 112 of the tank 102 to define, within the main chamber 124, an inlet volume 212 between the first nozzle wall 202 and the front wall 112. As FIGS. 2 and 3 further depict, the first nozzle wall 202 has at least one first baffle nozzle 214 formed therein. In the depicted embodiment, the at least one first baffle nozzle 214 extends lengthwise along the first nozzle wall 202 between the first end wall 106 of the tank 102 and the divider wall 122. It will be appreciated that the dimensions of the at least one first baffle nozzle 214 may vary to meet desired performance characteristics.

The first baffle wall 204 is disposed within the main chamber 124 and is spaced apart from the first nozzle wall 202 to define, within the main chamber 124, a first mixing volume 216 between itself and the first nozzle wall 202. The first baffle wall 204 additionally has a plurality of first baffle openings 218 extending therethrough. It will be appreciated that the number and size of the first baffle openings 218 may vary. It will additionally be appreciated that the location of the first baffle openings 218 may vary. Preferably, however, each is located near the top wall 116 of the tank 102.

The second nozzle wall 206 is disposed within the main chamber 124 and is spaced apart from the first baffle wall 204 to define, within the main chamber 124, an intermediate volume 222 between itself and the first baffle wall 204. The second nozzle wall 206 has at least one second baffle nozzle 224 formed therein. In the depicted embodiment, the at least one second baffle nozzle 224 extends lengthwise along the second nozzle wall 206 between the first end wall 106 of the tank 102 and the divider wall 122. It will be appreciated that the dimensions of the at least one second baffle nozzle 224 may vary to meet desired performance characteristics. Preferably, however, the dimensions of the at least one second baffle nozzle 224 is substantially identical to the dimensions of the at least one first baffle nozzle 214.

The second baffle wall 208 is disposed within the main chamber 124 and is spaced apart from the second nozzle wall 206 to define, the within the main chamber 124, a second mixing volume 226 between itself and the second nozzle wall 206. The second baffle wall 208 is also spaced apart from the back wall 114 of the tank 102 to define, within the main chamber 124, an outlet volume 228. Similar to the first baffle wall 204, the second baffle wall 208 has a plurality of second baffle openings 232 extending therethrough. It will be appreciated that the number and size of the second baffle openings 232 may vary. It will additionally be appreciated that the location of the second baffle openings 232 may vary. Preferably, however, each is located near the top wall 116 of the tank 102.

As noted above, the divider wall 122 has a divider wall opening 136 formed therein that provides fluid communication between the main chamber 124 and the settling chamber 126. More specifically, however, the divider wall opening 136 provides fluid communication between the outlet volume 228 and the settling chamber 126. It will be appreciated that the size and shape of the divider wall opening 136 may vary to meet desired performance characteristics. In one particular embodiment, the divider wall opening 136 is a relatively large (e.g., 48-inch×29 inch), rectangular-shaped opening. No matter the size and shape of the divider wall opening 136, and as FIG. 2 further depicts, a settling tank baffle wall 234 may, in some embodiments, be disposed within the settling chamber 126. The settling tank baffle wall 234, when included, has a third baffle opening 236 extending therethrough and is provided, when needed or desired, to reduce mist entrainment within the settling chamber 126.

As FIG. 2 further depicts, a plurality of first fluid openings 238 extend through each of the first nozzle wall 202, the first baffle wall 204, the second nozzle wall 206, and the second baffle wall 208 and are located adjacent the bottom wall 118 of the tank 102. These first fluid openings 238 provide fluid communication between the inlet volume 212, the first mixing volume 216, the intermediate volume 222, the second mixing volume 226, and the outlet volume 228 to ensure an even fluid level within the main chamber 124. In addition, as shown most clearly in FIG. 3, a second fluid opening 242 extends through the divider wall 122 and is also located adjacent to the bottom wall 118 of the tank 102. The second fluid opening 242 provides fluid communication between the settling chamber 126 and the main chamber 124 to allow any fluid that condenses within the settling chamber 126 to flow into the main chamber 124.

It should be noted that during operation of the distillation system 100, fluid within the main chamber 124 is maintained at or above a predetermined fluid level 244, which is illustrated in FIG. 3 using a dashed line. As FIG. 3 also depicts, the at least one first baffle nozzle 214 and the at least one second baffle nozzle 224 are each located below the predetermined fluid level 244, whereas the plurality of first baffle openings 218 and the plurality of second baffle openings 232 are each located above the predetermined fluid level 244. Although various techniques could be used to maintain the fluid within the main chamber 124 at or above the predetermined fluid level 244, in the depicted embodiment, and as FIG. 1 further depicts, the distillation system 100 may additionally include a fluid source 142, a fluid pump 144, and a fluid level sensor 146.

The fluid source 142, which may be variously configured, is the source of the fluid that is to be distilled by the distillation system 100. The fluid pump 144 is disposed between, and is in fluid communication with, the fluid source 142 and the main chamber 124. The fluid pump 144, which may be implemented using any one of numerous known fluid pumps, is configured to maintain the fluid within the main chamber 124 at or above the predetermined fluid level 244. The fluid level sensor 146 may be disposed on or within the tank 102. The fluid level sensor 146, which may be implemented using any one of numerous types of sensors, is configured to sense the fluid level within the main chamber 124 and, in the depicted embodiment, supply a fluid level signal to the fluid pump 144.

Having described the overall structure of the distillation system 100, the operation of the distillation system 100 will now be briefly described. In doing so, reference should be made to FIGS. 1 and 4. Before the gas turbine engine 104 is started, the fluid pump 144 is operated to supply fluid, from the fluid source 142, to the tank 102, and is then used to maintain the fluid level at the predetermined fluid level 244. Thereafter, the gas turbine engine 104 is started, and exhaust gas that is discharged from the gas turbine engine 104 is directed, via the diffuser 138, into the main chamber 124. More specifically, as FIG. 4 depicts, the exhaust gas 402 is directed, via the diffuser 138, into the inlet volume 212 and begins heating and perturbing the fluid within the tank 102.

The exhaust gas 402, along with some entrained fluid, is then directed into and through the at least one first baffle nozzle 214 and into the first mixing volume 216. The exhaust gas 402, together with any fluid that, due to heating, has been converted into a gas, such as steam, is directed through the first baffle openings 218 and into the intermediate volume 222. In the intermediate volume 222, the exhaust gas 402, along with some entrained fluid, is then directed into and through the at least one second baffle nozzle 224 and into the second mixing volume 226.

In the second mixing volume 226, the exhaust gas 402, together with any fluid that, due to heating, has been converted into a gas, such as steam, is directed through the second baffle openings 232 and into the outlet volume 228. From there, the exhaust gas 402, together with any fluid that has been converted into a gas, such as steam, is directed through the divider wall opening 136 and into the settling chamber 126. The exhaust gas 402, together with any fluid that has been converted into a gas, such as steam, is then discharged from the settling chamber 126 via the exhaust gas outlet port 134. The exhaust gas 402 and steam may be discharged to the atmosphere or directed to a condensing section to recondense the steam to water.

As may be appreciated, the distillation process implemented by the distillation system 100 will result in any dissolved salts, metals, and/or other contaminants to concentrate within the fluid that remains in the tank 102 and/or to precipitate out of the fluid that remains in the tank 102. These dissolved salts, metals, and/or other contaminants can be collected for proper disposal and/or reclamation.

The distillation system 100 described herein can be used to treat wastewater from various industrial processes, such as fracking, and does so relatively less costly and/or relatively less complex as compared to known systems.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A distillation system, comprising:
a tank having a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having a divider wall opening formed therein that provides fluid communication between the main chamber and the settling chamber;
a diffuser disposed within the main chamber and coupled to the exhaust gas inlet port; and
a gas turbine engine in fluid communication with the exhaust gas inlet port, the gas turbine engine configured, during operation thereof, to discharge exhaust gas into the main chamber via the diffuser.

2. The distillation system of claim 1, further comprising:
a first nozzle wall disposed within the main chamber and coupled to the diffuser, the first nozzle wall spaced apart from the front wall of the tank to define, within the main chamber, an inlet volume between the first nozzle wall and the front wall, the first nozzle wall having at least one first baffle nozzle formed therein;
a first baffle wall having a plurality of first baffle openings extending therethrough, the first baffle wall disposed within the main chamber and spaced apart from the first nozzle wall to define, within the main chamber, a first mixing volume between the first nozzle wall and the first baffle wall;
a second nozzle wall disposed within the main chamber and spaced apart from the first baffle wall to define, within the main chamber, an intermediate volume, the second nozzle wall having at least one second baffle nozzle formed therein; and
a second baffle wall having a plurality of second baffle openings extending therethrough, the second baffle wall disposed within the main chamber and spaced apart from the second nozzle wall to define, the within the main chamber, a second mixing volume between the second nozzle wall and the second baffle wall, the second baffle wall further spaced apart from the back wall of the tank to define, within the main chamber, an outlet volume.

3. The distillation system of claim 2, wherein the outlet volume is in fluid communication with the settling chamber via the divider wall opening.

4. The distillation system of claim 2, further comprising:
a settling tank baffle wall disposed within the settling chamber and having a third baffle opening extending therethrough.

5. The distillation system of claim 2, further comprising:
a plurality of first fluid openings extending through each of the first nozzle wall, the first baffle wall, the second nozzle wall, and the second baffle wall, the first fluid openings located adjacent the bottom wall of the tank and providing fluid communication between the inlet volume, the first mixing volume, the intermediate volume, the second mixing volume, and the outlet volume.

6. The distillation system of claim 5, further comprising:
a second fluid opening extending through the divider wall and located adjacent to the bottom wall of the tank, the second fluid opening providing fluid communication between the settling chamber and the main chamber.

7. The distillation system of claim 2, wherein:
during operation, fluid within the main chamber is maintained at or above a predetermined fluid level;
the at least one first baffle nozzle and the at least one second baffle nozzle are each located below the predetermined fluid level; and
the plurality of first baffle openings and the plurality of second baffle openings are each located above the predetermined fluid level.

8. The distillation system of claim 7, further comprising:
a fluid source; and
a fluid pump disposed between, and in fluid communication with, the fluid source and the main chamber, the fluid pump configured to maintain the fluid within the main chamber at or above the predetermined fluid level.

9. The distillation system of claim 8, further comprising:
a fluid level sensor disposed on or within the tank, the fluid level sensor configured to sense the fluid level within the main chamber and supply a fluid level signal to the fluid pump.

10. The distillation system of claim 1, further comprising:
an engine control in operable communication with the gas turbine engine, and configured to control the operation of the gas turbine engine.

11. The distillation system of claim 1, further comprising:
an exhaust duct coupled between the gas turbine engine and the exhaust gas inlet port, the exhaust duct configured to direct the exhaust gas discharged from the gas turbine engine into the exhaust gas inlet port.

12. A distillation system, comprising:
a tank having a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having a divider wall opening formed therein that provides fluid communication between the main chamber and the settling chamber;
a diffuser disposed within the main chamber and coupled to the exhaust gas inlet port;
a first nozzle wall disposed within the main chamber and coupled to the diffuser, the first nozzle wall spaced apart from the front wall of the tank to define, within the main chamber, an inlet volume between the first nozzle wall and the front wall, the first nozzle wall having at least one first baffle nozzle formed therein;
a first baffle wall having a plurality of first baffle openings extending therethrough, the first baffle wall disposed within the main chamber and spaced apart from the first nozzle wall to define, within the main chamber, a first mixing volume between the first nozzle wall and the first baffle wall;
a second nozzle wall disposed within the main chamber and spaced apart from the first baffle wall to define, within the main chamber, an intermediate volume, the second nozzle wall having at least one second baffle nozzle formed therein; and
a second baffle wall having a plurality of second baffle openings extending therethrough, the second baffle wall disposed within the main chamber and spaced apart from the second nozzle wall to define, the within the main chamber, a second mixing volume between the second nozzle wall and the second baffle wall, the second baffle wall further spaced apart from the back wall of the tank to define, within the main chamber, an outlet volume;
a gas turbine engine in fluid communication with the exhaust gas inlet port, the gas turbine engine configured, during operation thereof, to discharge exhaust gas into the inlet volume via the diffuser; and
an engine control in operable communication with the gas turbine engine, and configured to control the operation of the gas turbine engine.

13. The distillation system of claim 9, wherein the outlet volume is in fluid communication with the settling chamber via the divider wall opening.

14. The distillation system of claim 2, further comprising:
a settling tank baffle wall disposed within the settling chamber and having a third baffle opening extending therethrough.

15. The distillation system of claim 2, further comprising:
a plurality of first fluid openings extending through each of the first nozzle wall, the first baffle wall, the second nozzle wall, and the second baffle wall, the first fluid openings located adjacent the bottom wall of the tank and providing fluid communication between the inlet volume, the first mixing volume, the intermediate volume, and the outlet volume.

16. The distillation system of claim 5, further comprising:
a second fluid opening extending through the divider wall and located adjacent to the bottom wall of the tank, the second fluid opening providing fluid communication between the settling chamber and the main chamber.

17. The distillation system of claim 2, wherein:
during operation, fluid within the main chamber is maintained at or above a predetermined fluid level;
the at least one first baffle nozzle and the at least one second baffle nozzle are each located below the predetermined fluid level; and
the plurality of first baffle openings and the plurality of second baffle openings are each located above the predetermined fluid level.

18. The distillation system of claim 7, further comprising:
a fluid source; and
a fluid pump disposed between, and in fluid communication with, the fluid source and the main chamber, the fluid pump configured to maintain the fluid within the main chamber at or above the predetermined fluid level.

19. The distillation system of claim 8, further comprising:
a fluid level sensor disposed on or within the tank, the fluid level sensor configured to sense the fluid level within the main chamber and supply a fluid level signal to the fluid pump.

20. The distillation system of claim 1, further comprising:
an exhaust duct coupled between the gas turbine engine and the exhaust gas inlet port, the exhaust duct configured to direct the exhaust gas discharged from the gas turbine engine into the exhaust gas inlet port.
